(19) United States
(12) Patent Application Publication
(10) Pub. No.: US 2012/0318412 A1
(43) Pub. Date: Dec. 20, 2012

(54) PRIMARY ULTRAFINE-CRYSTALLINE ALLOY, NANO-CRYSTALLINE, SOFT MAGNETIC ALLOY AND ITS PRODUCTION METHOD, AND MAGNETIC DEVICE FORMED BY NANO-CRYSTALLINE, SOFT MAGNETIC ALLOY

(75) Inventors: Motoki Ohta, Osaka (JP); Yoshihito Yoshizawa, Osaka (JP); Taku Miyamoto, Tottori (JP); Toshio Mihara, Tottori (JP)

(73) Assignee: HITACHI METALS, LTD., Minato-ku, Tokyo (JP)

(21) Appl. No.: 13/580,820

(22) PCT Filed: Mar. 28, 2011
(86) PCT No.: PCT/JP2011/057714

§ 371 Date: Aug. 23, 2012

(30) Foreign Application Priority Data
Mar. 29, 2010 (JP) 2010-074623

(51) Int. Cl. H01F 1/01; C21D 6/00; H01F 41/02; C22C 45/02

(52) U.S. Cl. 148/548; 148/403; 148/304

(57) ABSTRACT

A primary ultrafine-crystalline alloy having a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 5-30% by volume of primary ultrafine crystal grains having an average particle size of 30 nm or less are dispersed in an amorphous matrix; its differential scanning calorimetry (DSC) curve having a first exothermic peak and a second exothermic peak lower than the first exothermic peak between a crystallization initiation temperature T_{X1} and a compound precipitation temperature T_{X3}; and a ratio of the heat quantity of the second exothermic peak to the total heat quantity of the first and second exothermic peaks being 3% or less.

### FIELD OF THE INVENTION

The present invention relates to a nano-crystalline, soft magnetic alloy having a high saturation magnetic flux density and excellent soft magnetic properties suitable for various magnetic devices, and a primary ultrafine-crystalline alloy as an intermediate alloy for producing it, a method for producing a nano-crystalline, soft magnetic alloy, and a magnetic device formed by a nano-crystalline, soft magnetic alloy.

### BACKGROUND OF THE INVENTION

Soft magnetic materials used for various reactors, choke coils, magnetic pulse power devices, transformers, magnetic cores for motors and power generators, current sensors, magnetic sensors, antenna cores, electromagnetic-wave-absorbing sheets, etc. include silicon steel, ferrite, amorphous alloys, nano-crystalline alloys, etc. Silicon steel is inexpensive and has a high magnetic flux density, but it suffers large core loss at high frequencies, and it cannot easily be made thin. Because of a low saturation magnetic flux density, ferrite is easily saturated magnetically in high-power applications with large operation magnetic flux densities. Co-based amorphous alloys are expensive and have as low saturation magnetic flux density as 1 T or less, providing large parts when used for high-power applications. In addition, because of thermal instability, the Co-based amorphous alloys change with time, resulting in increased core loss. Accordingly, Fe-based, nano-crystalline alloys are promising.

JP 2007-107095 A discloses a nano-crystalline, soft magnetic alloy represented by a composition formula of Fe_{100-x-y-z}CuₓB_{y}X_{z}, wherein X is at least one element selected from the group consisting of Si, S, C, P, Al, Ge, Ga and Be, and x, y and z are numbers (by atomic %) meeting the conditions of 0.1≦x≦3.0, 10≦y≦20, 0<z≦10.0, and 10<y+z≦24, at least part of its structure comprising 30% or more by volume of crystal grains having crystal grain sizes of 60 nm or less in an amorphous matrix, thereby having as high a saturation magnetic flux density as 1.7 T or more and low coercivity. This nano-crystalline, soft magnetic alloy is produced by quenching an Fe-based alloy melt to form an Fe-based, amorphous alloy ribbon in which fine crystal grains having an average particle size of 30 nm or less are precipitated in a proportion of less than 30% by volume in an amorphous phase, and subjecting the Fe-based, amorphous alloy ribbon to a high-temperature heat treatment for a short period of time or a low-temperature heat treatment for a long period of time. Because this Fe-based, amorphous alloy has primary fine crystals acting as nuclei for a nano-crystalline structure, it exhibits a peculiar exothermic pattern. Namely, a first broad exothermic peak indicating crystallization, which appears above a low-temperature-side crystallization initiation temperature T_{X}1 spreads to a third exothermic peak indicating the precipitation and growth of fine crystals, which appears above a high-temperature-side compound precipitation temperature T_{X3}, in differential scanning calorimetry (DSC).

JP 2008-231533 A discloses an Fe-based, soft-magnetic alloy ribbon having a composition represented by Fe_{100-x-y}AₓX_{y}, wherein A is Cu and/or Au, X is at least one element selected from the group consisting of B, Si, S, C, P, Al, Ge, Ga and Be, x and y are numbers (by atomic %) meeting the conditions of 0≦x≦5, and 10≦y≦24, and having a matrix phase structure in a depth of more than 120 nm from the ribbon surface, in which body-centered-cubic crystal grains having an average diameter of 60 nm or less are dispersed at a volume fraction of 30% or more in an amorphous matrix, and an amorphous layer in a depth within 120 nm from the ribbon surface. It is likely in this alloy ribbon that a nano-crystal layer is formed on the surface side, with an amorphous layer formed inside the nano-crystal layer, and a coarse crystal grain layer formed between the amorphous layer and the matrix. The coarse crystal grain layer exhibits good squareness in a low magnetic field. This reference describes that to reduce core loss, a crystal grain size in the coarse crystal grain layer is desirably 2 times or less the average crystal grain size of the matrix.

However, investigation for the stable mass production of the nano-crystalline, soft magnetic alloy of JP 2007-107095 A having a high saturation magnetic flux density and low coercivity and the amorphous alloy ribbon (also called “primary ultrafine-crystalline alloy”) of JP 2008-231533 A has revealed that they suffer such problems as not encountered in production using small, experimental apparatuses. For example, in the mass production of wide ribbons for a long period of time, ribbons are easily broken, resulting in low yield, and have poor handleability in rewinding them on reels for shipment, winding them to form cores, etc. Also, hysteresis remains at 1.5 T or more, adversely affecting their magnetic saturation and alternating magnetic properties. These problems appear to occur due to the fact that the density of primary fine crystals and the surface structures of ribbons change during production for a long period of time. However, the characteristics of amorphous alloy ribbons (primary ultrafine-crystalline alloy) for producing nano-crystalline, soft magnetic alloys are not sufficiently evaluated, and the influence of a coarse crystal grain layer on soft magnetic properties is also not sufficiently investigated.

### OBJECTS OF THE INVENTION

Accordingly, an object of the present invention is to improve the nano-crystalline, soft magnetic alloys of JP 2007-107095 A and JP 2008-231533 A, providing a primary ultrafine-crystalline alloy containing nuclei of fine crystals with adjusted crystallization, and a nano-crystalline, soft magnetic alloy obtained by heat-treating this primary ultrafine-crystalline alloy for having improved toughness and a good balance of magnetic properties and handling.

Another object of the present invention is to provide a method for mass-producing an excellent nano-crystalline, soft magnetic alloy by setting optimum heat treatment conditions for the primary ultrafine-crystalline alloy under inevitably variable production conditions.

### SUMMARY OF THE INVENTION

The primary ultrafine-crystalline alloy of the present invention has a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 5-30% by volume of primary ultrafine crystal grains having an average particle size of 30 nm or less are dispersed in an amorphous matrix; its differential scanning calorimetry (DSC) curve having a first exothermic peak and a second exothermic peak lower than the first exothermic peak between a crystallization initiation temperature T_{X1} and a compound precipitation temperature T_{X3}; and a ratio of the heat quantity of the second exothermic peak to the total heat quantity of the first and second exothermic peaks being 3% or less.

The nano-crystalline, soft magnetic alloy of the present invention has a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 30% or more by volume of fine crystal grains having an average particle size of 60 nm or less are dispersed in an amorphous matrix; the depth of a layer containing coarse crystal grains having an average particle size 2 times or more the average crystal grain size of the fine crystal grains being 2.9 μm or less from the surface.

The nano-crystalline, soft magnetic alloy is obtained by heat-treating the primary ultrafine-crystalline alloy.

The method of the present invention for producing a nano-crystalline, soft magnetic alloy having a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 30% or more by volume of fine crystal grains having an average particle size of 60 nm or less are dispersed in an amorphous matrix, comprises the steps of

ejecting an alloy melt having the composition onto a rotating cooling roll for quenching, thereby producing a primary ultrafine-crystalline alloy having a structure in which 5-30% by volume of primary ultrafine crystal grains having an average particle size of 30 nm or less are dispersed in an amorphous matrix, the surface temperature of the cooling roll being kept at such a temperature that a differential scanning calorimetry (DSC) curve of the primary ultrafine-crystalline alloy has a first exothermic peak and a second exothermic peak lower than the first exothermic peak between a crystallization initiation temperature T_{X1} and a compound precipitation temperature T_{X3}, and that a ratio of the heat quantity of the second exothermic peak to the total heat quantity of the first and second exothermic peaks is 3% or less; and then

subjecting the primary ultrafine-crystalline alloy to a heat treatment comprising temperature elevation to the highest temperature of (T_{X3}−50° C.) to (T_{X3}−30° C.), for 5-30 minutes including a temperature-elevating time and a highest-temperature-keeping time.

The cooling roll is preferably cooled with water, the inlet temperature (temperature immediately before entering the cooling roll) of cooling water being controlled to 30-70° C., and the outlet temperature (temperature immediately after exiting from the cooling roll) of the cooling water being kept at 40-80° C. The temperature elevation of cooling water in the cooling roll is preferably about 10-30° C. The surface temperature of the ribbon when stripped from the cooling roll is preferably controlled at 170-350° C.

The second exothermic peak in the DSC curve has a start temperature T_{X2S} and an end temperature T_{X2E} between 400° C. and 460° C. The target temperature of the heat treatment is preferably set at T_{X2E}±20° C.

In the production methods of the primary ultrafine-crystalline alloy and the nano-crystalline, soft magnetic alloy, part of Fe may be substituted by 0.1-2 atomic % of Ni.

The magnetic device of the present invention is formed by the above nano-crystalline, soft magnetic alloy.

### BRIEF DESCRIPTION OF THE DRAWINGS

FIG. 1(a) is a schematic view showing a cross section near a roll-contacting surface of a primary ultrafine-crystalline alloy produced by using a low-cooling-power roll.

FIG. 1(b) is a schematic view showing a cross section near a roll-contacting surface of a primary ultrafine-crystalline alloy produced by using a high-cooling-power roll.

FIG. 2 is a graph showing a DSC curve having a first exothermic peak generated by the nano-crystallization of an amorphous matrix and a third exothermic peak generated by the precipitation of compounds.

FIG. 3 is a graph showing a DSC curve having a second exothermic peak generated by the formation of coarse crystal grains.

FIG. 4(a) is a graph showing a B-H curve when the coarse crystal grain layer is thin.

FIG. 4(b) is a graph showing a B-H curve when the coarse crystal grain layer is thick.

FIG. 5(a) is a schematic view showing a method for determining the total heat quantity of first and second exothermic peaks in a DSC curve.

FIG. 5(b) is a schematic view showing a method for determining the heat quantity of a second exothermic peak in the DSC curve.

FIG. 6 is a schematic cross-sectional view showing a cooling roll used in the method of the present invention.

FIG. 7 is a graph showing cooling speed distributions in a ribbon thickness direction in both cases of low and high inlet temperatures of cooling water.

FIG. 8 is a graph showing a DSC curve of the nano-crystalline, soft magnetic alloy ribbon of Example 1 having a composition of Fe_{bal}Cu_{1.4}Si₄B₁₄.

FIG. 9 is a graph showing a pattern of a high-temperature, short-period heat treatment and a pattern of a low-temperature, long-period heat treatment.

FIG. 10 is a graph showing B-H curves in both cases where a nano-crystalline, soft magnetic alloy ribbon having a composition of Fe_{bal.}Cu_{1.4}Si₄B₁₄ was subject to a high-temperature, short-period heat treatment and a low-temperature, long-period heat treatment.

FIG. 11 is a graph showing the relation between a magnetic flux density B₈₀ at 80 A/m and a ratio of the second exothermic peak.

FIG. 12 is a graph showing the relation between B₈₀/B₈₀₀₀ and a ratio of the second exothermic peak.

FIG. 13(a) is a TEM photograph showing a cross section of the nano-crystalline, soft magnetic alloy ribbon of Example 3-7 near a roll-contacting surface.

FIG. 13(b) is a TEM photograph showing a cross section of the nano-crystalline, soft magnetic alloy ribbon of Comparative Example 3-1 near a roll-contacting surface.

FIG. 14 is a graph showing the relation between coercivity Hc and a ratio of the second exothermic peak in the nano-crystalline, soft magnetic alloy ribbon of Example 4.

FIG. 15 is a graph showing the relation between coercivity Hc and a ratio of the second exothermic peak in the nano-crystalline, soft magnetic alloy ribbon of Example 5.

### DESCRIPTION OF THE PREFERRED EMBODIMENTS

The primary ultrafine-crystalline alloy and the nano-crystalline, soft magnetic alloy according to the present invention are usually in a ribbon form, but they may be in a powder or flake form. Taking the ribbon form for example, these alloys will be explained in detail below, but it should be noted that they are of course not restricted to be in a ribbon form. The term “primary ultrafine crystal grains” used herein means crystal nuclei precipitated in an amorphous alloy obtained by quenching an alloy melt, which grow to fine crystal grains by a heat treatment. The amorphous alloy is called “primary ultrafine-crystalline alloy,” because the primary ultrafine crystal grains, nuclei for fine crystal grains, are precipitated. The term “fine crystal grains” means fine crystal grains grown from the primary ultrafine crystal grains by a heat treatment.

[1] Crystallization and Exothermic Peaks of Primary Ultrafine-Crystalline Alloy

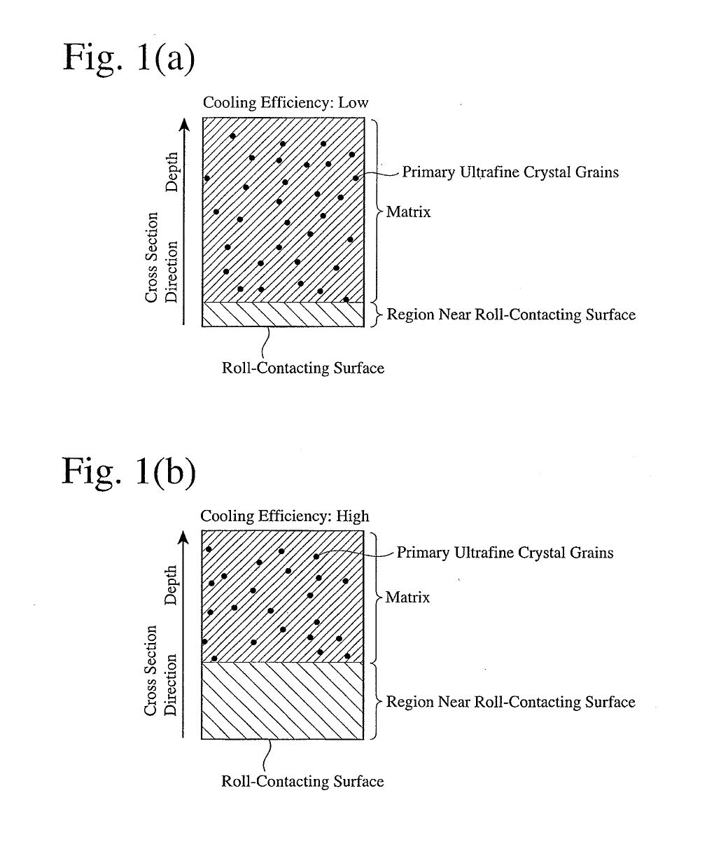

FIG. 1(a) shows the structure of a primary ultrafine-crystalline alloy near a cooling-roll-contacting surface, which was produced using a cooling roll having low cooling power (low cooling efficiency), and FIG. 1(b) shows the structure of a primary ultrafine-crystalline alloy near a cooling-roll-contacting surface, which was produced using a cooling roll having high cooling power (high cooling efficiency). Cu atoms are aggregated by diffusion during cooling at positions separate from the rolling surface to form Cu clusters (orderly lattice of about several nm), which act as nuclei to precipitate primary ultrafine crystal grains. When a cooling roll having as such a low cooling power as an experimental level is used, primary ultrafine crystal grains are precipitated even in a region near the roll-contacting surface, at a relatively high density evenly in a cross section direction of the alloy, preventing crystal grains from becoming coarser, and providing a high compound precipitation temperature T_{X3} because of a drastic reduction of the Fe content in a remaining amorphous phase. On the other hand, in the case of a high-cooling-power roll for mass production, the diffusion of Cu is suppressed near a roll-contacting surface, making the formation of Cu clusters difficult, and thus resulting in an extremely low number density of primary ultrafine crystal grains. This tendency is remarkable more on the roll-contacting surface side than on the free surface, though it appears on the free surface side, too.

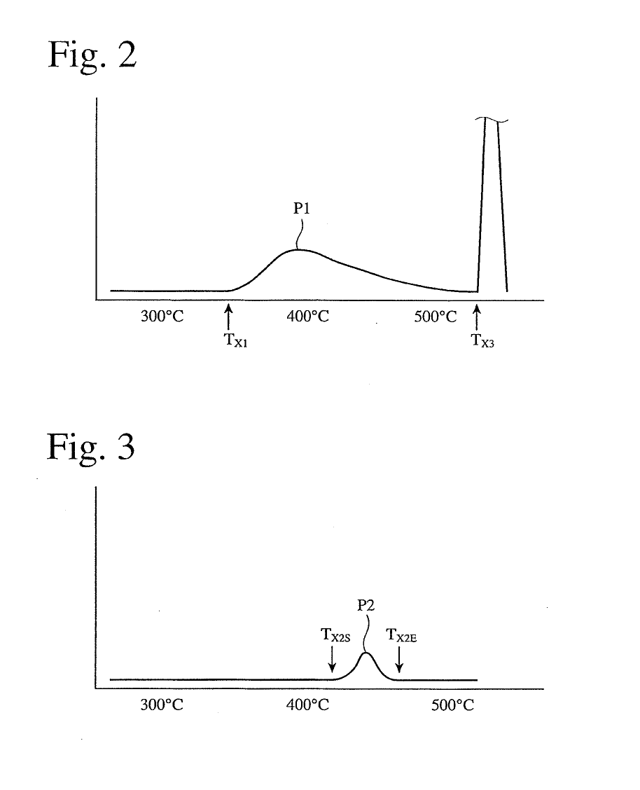

When the primary ultrafine-crystalline alloy is heat-treated, nano-crystallization progresses slowly in a range of 100° C. or more from the nano-crystallization initiation temperature T_{X1} to the compound precipitation temperature T_{X3}, because of a low growth (nano-crystallization) speed from the primary ultrafine crystal grains to fine crystal grains. As a result, as shown in FIG. 2, a DSC curve has a first broad exothermic peak P1 due to heat generation by nano-crystallization between 300° C. and 500° C., between the nano-crystallization initiation temperature T_{X1} and the compound precipitation temperature T_{X3}.

It has been considered that the nano-crystallization process removes Fe from a remaining amorphous phase, stabilizing it because of a higher boron concentration, and thus suppressing the growth of crystal grains. However, when the primary ultrafine-crystalline alloy is continuously produced, a second exothermic peak P2 appeared in a narrow temperature range of about 400-460° C., for example, in the first exothermic peak P1 as shown in FIG. 3. It has been found that the second exothermic peak P2 appears by heat generation due to the crystallization of the amorphous phase in a region with few primary ultrafine crystal grains near the roll-contacting surface (region poor in primary ultrafine crystal grains). It has been found that because the amorphous phase is rapidly crystallized by a heat treatment in a region with few primary ultrafine crystal grains, crystal grains grow coarser than fine crystal grains in the matrix, and a deep region poor in primary ultrafine crystal grains provides a deep coarse crystal grain layer, resulting in large effective crystal magnetic anisotropy and poor magnetic saturation characteristics.

[2] Influence of Coarse Crystal Grain Layer on Soft Magnetic Properties

The nano-crystalline, soft magnetic alloy of the present invention has a composite structure comprising a nano-crystal layer, an amorphous layer, and a nano-crystal grain layer in this order from the surface. The coarse crystal grain layer may be regarded as an amorphous layer in which coarse crystal grains are precipitated. The term “layer” used herein means not a layer partitioned by a clear boundary, but a thickness direction range meeting the predetermined conditions. For example, the nano-crystal layer is an extremely thin range in which fine crystal grains of about 20 nm are precipitated, and the coarse crystal grain layer is a thickness direction range containing coarse crystal grains having an average particle size as large as 2 times or more that of fine crystal grains in the matrix. Specifically, the depth of the coarse crystal grain layer from the surface is 2.9 μm or less, preferably 2.7 μm or less, more preferably 0.5-2.5 μm.

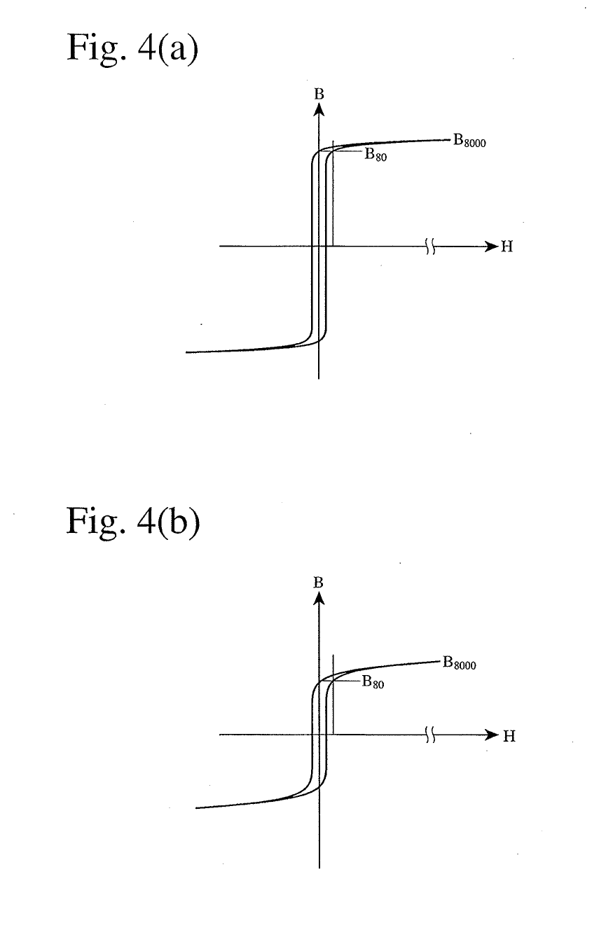

A thin coarse crystal grain layer has a large ratio of B₈₀/B₈₀₀₀ as shown by a B-H curve in FIG. 4(a), wherein B₈₀ represents a magnetic flux density in a low magnetic field (80 A/m), and B₈₀₀₀ represents a magnetic flux density (substantially equal to a saturation magnetic flux density Bₛ) in a high magnetic field (8000 A/m), resulting in good soft magnetic properties. On the other hand, a thick coarse crystal grain layer has small B₈₀/B₈₀₀₀ as shown by a B-H curve in FIG. 4(b). In general, the larger the ratio B₈₀/B₈₀₀₀, the better the saturation magnetization characteristics. The ratio B₈₀/B₈₀₀₀ is preferably 0.85 or more, more preferably 0.88 or more.

The coercivity H_{c} depends not only on the average crystal grain size of the matrix structure but also on the ratio of the second exothermic peak. As described above, in a primary ultrafine-crystalline alloy produced using a high-cooling-power roll, quenching effects reach deeper portions of the alloy, resulting in a deeper region poor in primary ultrafine crystal grains, resulting in large coercivity H_{c}.

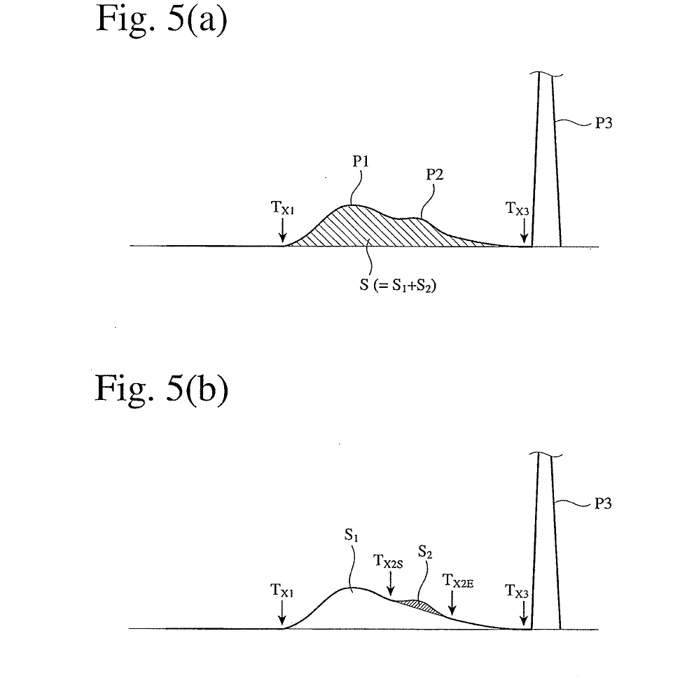

To meet both conditions of high B₈₀/B₈₀₀₀ and low coercivity H_{c}, it is necessary to produce a primary ultrafine-crystalline alloy with the formation of a coarse crystal grain layer suppressed. A DSC curve obtained by heat-treating such primary ultrafine-crystalline alloy shows a small ratio of a second exothermic peak to the total quantity of exothermic heat by nano-crystallization. The total quantity of exothermic heat by nano-crystallization is a sum of the first and second exothermic peaks, corresponding to an area S of a region surrounded by a curve from T_{X1} to T_{X3} and a straight line passing the two points in a DSC curve shown in FIG. 5(a). As shown in FIG. 5(b), the exothermic heat of the second exothermic peak P2 corresponds to an area S₂ of a region surrounded by a curve from a start temperature T_{X2S} to an end temperature T_{X2E} of the second exothermic peak P2 and a straight line passing the two points. The exothermic heat of the first exothermic peak P1 corresponds to an area S₁ (=S−S₂). Accordingly, a ratio of the second exothermic peak to the total quantity of exothermic heat by nano-crystallization is obtained by S₂/S.

Specifically, when the ratio of the heat quantity of the second exothermic peak P2 to the total quantity of exothermic heat by nano-crystallization is 3% or less, B₈₀/B₈₀₀₀ is 0.85 or more, and a smaller second exothermic peak provides a larger ratio of B₈₀/B₈₀₀₀. The second exothermic peak ratio of 1.5% or less provides sufficiently small coercivity H_{c}. Accordingly, the ratio of the second exothermic peak is preferably 0-3%, more preferably 0-1.5%, more preferably 0-1.3%.

The level of the second exothermic peak generated by the formation of coarse crystal grains depends on the cooling power of the cooling roll, and the cooling power is determined by the surface temperature and peripheral speed of the cooling roll, a temperature when the alloy is stripped from the cooling roll, etc. In general, too high cooling power increases a region poor in primary ultrafine crystal grains, so that coarse crystal grains increase by a heat treatment. In addition, because the second exothermic peak appears by a continuous operation for a long period of time, it is presumed that the surface temperature of the cooling roll changes during a continuous operation for a long period of time. Accordingly, in addition to the peripheral speed of the cooling roll and the stripping temperature, the temperature of cooling water affecting the surface temperature of the cooling roll should be adjusted.

[3] Magnetic Alloy

(1) Composition

The nano-crystalline magnetic alloy of the present invention has a composition represented by the general formula of Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25. To have a saturation magnetic flux density Bs of 1.7 T or more, it should have a fine (nano-crystalline) bcc-Fe crystal structure, needing a high Fe content. Specifically, the Fe content is 75 atomic % or more, preferably 77 atomic % or more.

In the above composition range, a region meeting 0.3≦x≦2.0, 10≦y≦20, and 1≦z≦10 provides a saturation magnetic flux density of 1.74 T or more. Also, a region meeting 0.5≦x≦1.5, 10≦y≦18, and 2≦z≦9 provides a saturation magnetic flux density of 1.78 T or more. Further, a region meeting 0.5≦x≦1.5, 10≦y≦16, and 3≦z≦9 provides a saturation magnetic flux density of 1.8 T or more.

To have good soft magnetic properties and a saturation magnetic flux density Bs of 1.7 T or more, this alloy has a basic composition of Fe—B—Si having a stably amorphous phase even at a high Fe content, and containing the nuclei-forming element A. Specifically, Cu and/or Au (nuclei-forming elements A) not soluble in Fe are added to an Fe—B—Si alloy containing 88 atomic % or less of Fe, which stably forms ribbons having an amorphous phase as a main phase, to precipitate primary ultrafine crystal grains, which homogeneously grow to fine crystal grains by a subsequent heat treatment.

When the amount (x) of the element A is too small, fine crystallization is difficult. Oppositely, when it exceeds 5 atomic %, melt-quenched ribbons having amorphous phases as main phases are brittle. The amount (x) of the element A is preferably 0.3-2 atomic %, more preferably 0.5-1.6 atomic %, most preferably 1-1.5 atomic %, particularly 1.2-1.5 atomic %. The element A is preferably Cu from the aspect of cost. When Au is contained, the amount of Fe is preferably 1.5 atomic % or less.

B (boron) is an element accelerating the formation of an amorphous phase. When B is less than 10 atomic %, it is difficult to obtain ribbons having amorphous phases as main phases. More than 22 atomic % of B provides the alloy with a saturation magnetic flux density of less than 1.7 T. Accordingly, meeting the condition of 10≦y≦22 (atomic %) stably provides the amorphous phase while keeping a high saturation magnetic flux density. The amount (y) of B is preferably 12-20 atomic %, more preferably 12-18 atomic %, most preferably 12-16 atomic %.

The addition of the element X (particularly Si) elevates a temperature at which Fe—B or Fe—P (when P is added) having large crystal magnetic anisotropy is precipitated, making it possible to elevate the heat treatment temperature. High-temperature heat treatments increase the ratio of fine crystal grains, thereby improving Bs and squareness in a B-H curve while suppressing the deterioration or discoloration of ribbon surfaces. Though the amount (z) of the element X may have a lower limit of O atomic %, 1 atomic % or more of the element X forms an oxide layer of the element X on the ribbon surface, thereby sufficiently preventing the oxidation of the alloy. More than 10 atomic % of the element X provides Bs of less than 1.7 T. The amount (z) of the element X is preferably 2-9 atomic %, more preferably 3-8 atomic %, most preferably 4-7 atomic %. The element X is preferably Si.

Among the element X, P is an element for increasing the formability of an amorphous phase, suppressing the growth of fine crystal grains and the segregation of B in the oxide layer. Accordingly, P is preferable for high toughness, high Bs and good soft magnetic properties. P contained prevents cracking, even when a soft magnetic alloy ribbon is wound around a round rod having a radius of 1 mm, for example. This effect is obtained regardless of a temperature elevation speed in a nano-crystallization heat treatment. As the element X, other elements such as S, C, Al, Ge, Ga and Be may be used. Magnetostriction and magnetic properties can be adjusted by these elements. The element X is also easily segregated to the surface, effective for the formation of a strong oxide layer.

Part of Fe may be substituted by at least one element D selected from the group consisting of Ni, Mn, Co, V, Cr, Ti, Zr, Nb, Mo, Hf, Ta and W. The amount of the element D is preferably 0.01-10 atomic %, more preferably 0.01-3 atomic %, most preferably 0.01-1.5 atomic %. Among these elements D, Ni, Mn, Co, V and Cr move a high-B-concentration region toward the surface, forming a structure close to the matrix structure in a near surface region, thereby improving the soft magnetic properties (permeability, coercivity, etc.) of the soft magnetic alloy ribbon. Also, they are predominantly contained in the amorphous phase remaining after a heat treatment together with the element A and metalloid elements, suppressing the growth of high-Fe-content, fine crystal grains, reducing the average particle size of fine crystal grains, and thus improving saturation magnetic flux density Bs and soft magnetic properties.

Particularly when part of Fe is substituted with the element A and Co or Ni soluble in Fe, the maximum amount of the element A added increases, so that the crystal structure becomes finer, providing improved soft magnetic properties. The amount of Ni added is preferably 0.1-2 atomic %, more preferably 0.5-1 atomic %. Less than 0.1 atomic % of Ni is insufficient to improve handling, and more than 2 atomic % of Ni decreases Bₛ, B₈₀ and H_{c}.

Because Ti, Zr, Nb, Mo, Hf, Ta and W are also predominantly contained together with the element A and metalloid elements in the amorphous phase remaining after a heat treatment, they contribute to the improvement of a saturation magnetic flux density Bs and soft magnetic properties. Too much addition of these elements having large atomic weights decreases the Fe content per a unit weight, deteriorating soft magnetic properties. The total amount of these elements is preferably 3 atomic % or less. Particularly in the case of Nb and Zr, their total amount is preferably 2.5 atomic % or less, more preferably 1.5 atomic % or less. In the case of Ta and Hf, their total amount is preferably 1.5 atomic % or less, more preferably 0.8 atomic % or less.

(2) Matrix Structure

The heat-treated matrix has an amorphous phase, in which fine crystal grains having a body-centered cubic (bcc) structure and an average particle size of 60 nm or less are dispersed at a volume fraction of 30% or more. When the average particle size of fine crystal grains is more than 60 nm, the soft magnetic properties are low. When the volume fraction of fine crystal grains is less than 30%, the ratio of the amorphous phase is too high, resulting in a low saturation magnetic flux density. The average particle size of fine crystal grains after a heat treatment is preferably 40 nm or less, more preferably 30 nm or less. The lower limit of the average particle size of fine crystal grains is generally 12 nm, preferably 15 nm, more preferably 18 nm. The volume fraction of fine crystal grains after a heat treatment is preferably 50% or more, more preferably 60% or more. With the average particle size of 60 nm or less and the volume fraction of 30% or more, alloy ribbons have lower magnetostriction than those of Fe-based, amorphous alloys and excellent soft magnetic properties. Though an Fe-based, amorphous alloy ribbon having the same composition has relatively large magnetostriction because of a magnetic volume effect, the nano-crystalline, soft magnetic alloy of the present invention in which bcc-Fe-based, fine crystal grains are dispersed has much smaller magnetostriction, which is generated by the magnetic volume effect, exhibiting a large noise reduction effect.

[4] Production Method

(1) Alloy Melt

The alloy melt has a composition represented by Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25. Taking for example a case where Cu is used as the element A, the production method will be explained.

(2) Quenching of Melt

The quenching of the alloy melt can be conducted by a single-roll method. The melt temperature is preferably 50-300° C. higher than the melting point of the alloy. For example, when a ribbon as thick as several tens of microns in which primary ultrafine crystal grains are precipitated is produced, it is preferable to eject the melt at 1300° C. through a nozzle onto a cooling roll. An atmosphere in the single-roll method is the air or an inert gas (Ar, nitrogen, etc.) when the alloy does not contain active metals, and an inert gas (Ar, He, nitrogen, etc.) or vacuum when the alloy contains active metals. To form an oxide layer on the surface, the quenching of the melt is conducted preferably in an oxygen-containing atmosphere (for example, air).

The formation of primary ultrafine crystal grains has a close relation to the cooling speed and time of the alloy ribbon. Cu is aggregated by thermal diffusion to form clusters in the cooling process, thereby forming primary ultrafine crystal grains. Accordingly, the thermal diffusion does not occur easily in a surface region with a high cooling speed, so that primary ultrafine crystal grains are not easily formed, but a coarse crystal grain layer is formed (the second exothermic peak appears). Thus, it is important to control the volume fraction of primary ultrafine crystal grains. One of means for controlling the volume fraction of primary ultrafine crystal grains is to control the peripheral speed of the cooling roll. A higher peripheral speed of the cooling roll reduces the volume fraction of primary ultrafine crystal grains, while a lower peripheral speed of the cooling roll increases the volume fraction of primary ultrafine crystal grains. The peripheral speed of the cooling roll is preferably 15-50 m/s, more preferably 20-40 m/s, most preferably 25-35 m/s. Materials for the cooling roll are suitably pure copper or copper alloys such as Cu—Be, Cu—Cr, Cu—Zr, Cu—Zr—Cr, etc. having high thermal conductivity.

In mass production, or in the production of thick and/or wide ribbons, the cooling roll is preferably cooled with water. The water-cooling of the roll has large influence on the volume fraction of primary ultrafine crystal grains (the generation of the second exothermic peak). To control the second exothermic peak, it is effective to keep the cooling power, which may also be called “cooling speed,” of the cooling roll. In a mass production line, the cooling power of the cooling roll has a relation to the temperature of cooling water, making it effective to keep cooling water at a predetermined temperature or higher.

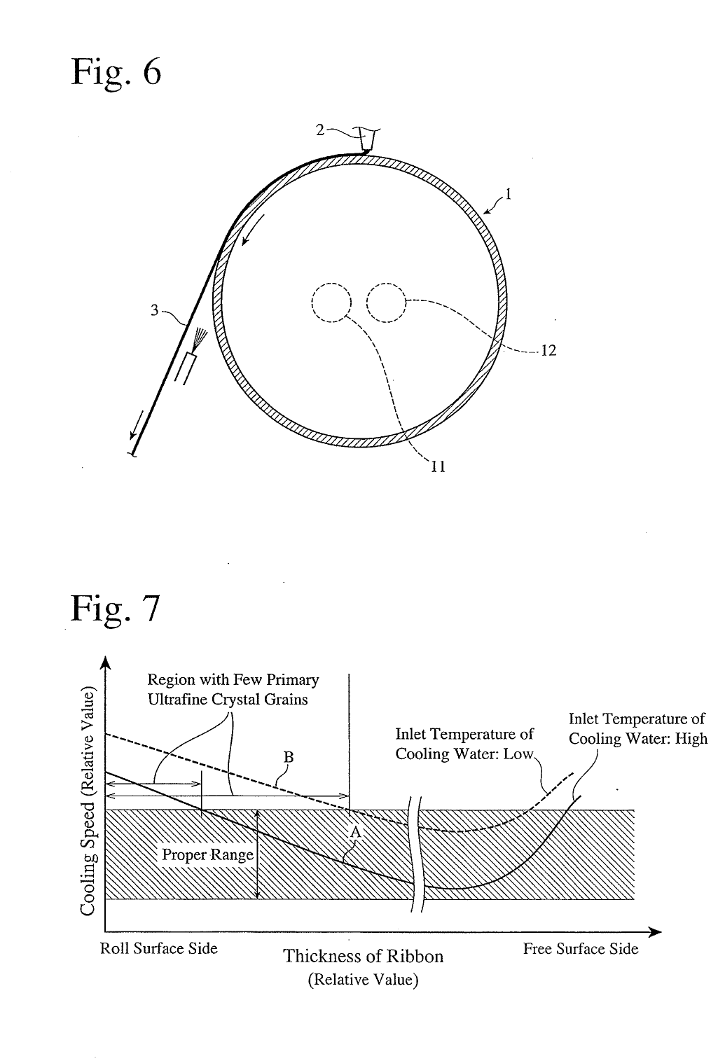

FIG. 6 shows the cross section structure of a cooling roll used in the method of the present invention. A nozzle 2 for ejecting an alloy melt is disposed near an upper surface of the cooling roll 1, and the alloy melt is quenched by the cooling roll 1 to form a ribbon 3 of a primary ultrafine-crystalline alloy. Provided on both ends of the cooling roll 1 are an inlet 11 and an outlet 12 of cooling water, which flows through a flow path between the inlet 11 and the outlet 12.

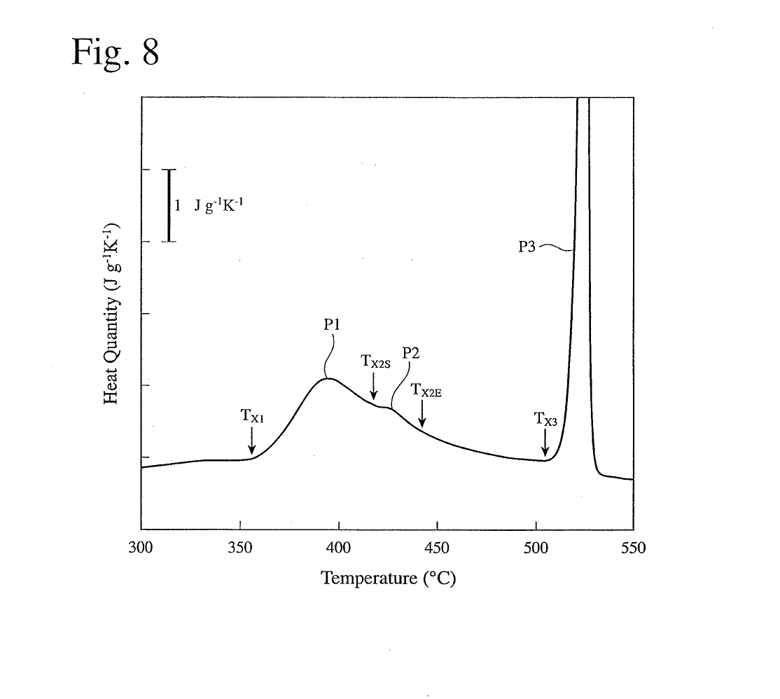

FIG. 7 shows a cooling speed distribution of the ribbon in a thickness direction. The cooling speed of the ribbon is highest in a portion in contact with a surface of the cooling roll 1, decreases as it becomes deeper, and slightly high on a free surface because of air cooling. As shown by the curve B, cooling water with a low inlet temperature, which provides a high cooling speed, forms a deep region poor in primary ultrafine crystal grains (primary ultrafine crystal grains have a low number density and an insufficient volume fraction), resulting in a high ratio of the second exothermic peak. As a result, the nano-crystalline, soft magnetic alloy has poor soft magnetic properties. On the other hand, as shown by the curve A, cooling water with a high inlet temperature, which provides a low cooling speed, forms a shallow region poor in primary ultrafine crystal grains, resulting in a low ratio of the second exothermic peak. As a result, the nano-crystalline, soft magnetic alloy has excellent soft magnetic properties. Thus, by adjusting the inlet temperature of cooling water, the cooling speed of the ribbon can be controlled, thereby reducing the ratio of the second exothermic peak, providing the resultant nano-crystalline, soft magnetic alloy with improved soft magnetic properties. Though variable depending on the alloy composition and production line conditions, the inlet temperature of cooling water is preferably 30-70° C., more preferably 40-70° C., most preferably 50-70° C. The outlet temperature of cooling water is preferably 40-80° C., more preferably 50-80° C.

(3) Stripping Temperature

With an inert gas (nitrogen, etc.) blown from a nozzle to a gap between the quenched alloy ribbon and the cooling roll, the alloy ribbon is stripped from the cooling roll. The stripping temperature of the alloy ribbon also appears to affect the volume fraction of primary ultrafine crystal grains. The stripping temperature of the ribbon can be adjusted by changing the position of an inert-gas-blowing nozzle (stripping position). The stripping temperature is 170-350° C., preferably 200-340° C., more preferably 250-330° C. When the stripping temperature is lower than 170° C., quenching proceeds to form a substantially amorphous alloy structure, failing to achieve the aggregation of Cu, the formation of Cu clusters and the precipitation of primary ultrafine crystal grains, and thus failing to obtain the primary ultrafine-crystalline alloy. When the above cooling roll has a proper cooling speed, a surface region of the ribbon is depleted with Cu by quenching, failing to have primary ultrafine crystal grains, but the cooling speed is relatively slow inside the ribbon, resulting in more primary ultrafine crystal grains uniformly distributed than in the surface region. As a result, a layer having a higher concentration of B (larger ratio of B to Fe) than in the inside matrix is formed in a surface region (depth: 30-130 nm). An amorphous layer having a high concentration of B near the surface provides the primary ultrafine-crystalline alloy ribbon with good toughness. When the stripping temperature is higher than 350° C., crystallization by Cu proceeds too much, failing to form an amorphous layer having a high concentration of B near the surface, and thus failing to obtain sufficient toughness.

Because the inside of the stripped primary ultrafine-crystalline alloy ribbon still has a relatively high temperature, the primary ultrafine-crystalline alloy ribbon is sufficiently cooled before winding, to prevent further crystallization. For example, the stripped primary ultrafine-crystalline alloy ribbon is cooled to substantially room temperature by blowing an inert gas (nitrogen, etc.), and then wound.

(4) Ribbon of Primary Ultrafine-Crystalline Alloy

The ribbon of the primary ultrafine-crystalline alloy has a structure comprising an amorphous matrix, in which 5-30% by volume of primary ultrafine crystal grains having an average particle size of 30 nm or less are dispersed. When the average particle size of primary ultrafine crystal grains is more than 30 nm, too coarse fine crystal grains are formed even by a heat treatment described below, resulting in poor soft magnetic properties. To obtain excellent soft magnetic properties, the average particle size of primary ultrafine crystal grains is preferably 25 nm or less, more preferably 20 nm or less, most preferably 10 nm or less, particularly 5 nm or less. The lower limit of the average particle size of the primary ultrafine crystal grains is preferably about 0.5 nm, taking the measurement limit into consideration. Because primary ultrafine crystal grains should exist in the amorphous matrix, the average particle size of primary ultrafine crystal grains is preferably 1 nm or more, more preferably 2 nm or more. The volume fraction of primary ultrafine crystal grains in the primary ultrafine-crystalline alloy ribbon is in a range of 5-30%. When the volume fraction of primary ultrafine crystal grains exceeds 30%, the average particle size of primary ultrafine crystal grains tends to be more than 30 nm, failing to provide the alloy ribbon with sufficient toughness, making its handling difficult in subsequent steps. Without primary ultrafine crystal grains (if completely amorphous), coarse crystal grains rather grow by a heat treatment. The volume fraction of primary ultrafine crystal grains is preferably 10-30%, more preferably 15-30%.

When an average distance between primary ultrafine crystal grains (distance between their centers of gravity) is 50 nm or less, the magnetic anisotropy of fine crystal grains is desirably averaged, resulting in low effective crystal magnetic anisotropy. The average distance of more than 50 nm provides little effect of averaging magnetic anisotropy, resulting in high effective crystal magnetic anisotropy and poor soft magnetic properties.

(5) Heat Treatment

To turn the primary ultrafine-crystalline alloy to a soft magnetic alloy having a high magnetic flux density, a heat treatment should be conducted at a temperature equal to or higher than the crystallization temperature for a short period of time. The primary ultrafine crystal grains easily become coarse in a region with few primary ultrafine crystal grains because of large intercrystal distances, but a high-temperature, short-period heat treatment terminates in the growing process of primary ultrafine crystal grains, preventing the primary ultrafine crystal grains from becoming coarse. The high-temperature, short-period heat treatment can be conducted by adjusting the temperature elevation speed, the highest temperature and the heat treatment time.

The heat treatment temperature should be equal to or higher than the crystallization initiation temperature T_{X1}, and equal to or lower than the compound precipitation temperature T_{X3}, preferably, for instance, in a range of 400-500° C. In conventional heat treatments, temperatures are elevated to a range from (T_{X1}+50° C.) to (T_{X1}+100° C.), and the heat treatment time including the temperature elevation time is about 30-120 minutes. In the present invention, however, temperature elevation is conducted to a relatively high temperature ranging from (T_{X3}−50° C.) to (T_{X3}−30° C.), and the heat treatment time including the temperature elevation time is as short as 5-30 minutes. This heat treatment improves a magnetic flux density B₈₀ at 80 A/m. The heat treatment temperature is preferably 430-470° C., and the heat treatment time including the temperature elevation time is preferably 10-25 minutes.

(a) Heat Treatment Atmosphere

Though the heat treatment atmosphere may be air, it has an oxygen concentration of preferably 6-18%, more preferably 8-15%, most preferably 9-13%, to form an oxide layer having a desired layer structure by the diffusion of Si, Fe, B and Cu toward the surface. The heat treatment atmosphere is preferably a mixed gas of an inert gas such as nitrogen, Ar, helium, etc. with oxygen. The dew point of the heat treatment atmosphere is preferably −30° C. or lower, more preferably −60° C. or lower.

(b) Heat Treatment in a Magnetic Field

To impart good induction magnetic anisotropy to the soft magnetic alloy ribbon by a heat treatment in a magnetic field, a magnetic field having sufficient intensity to saturate the soft magnetic alloy is preferably applied, in any periods selected from while the heat treatment temperature is 200° C. or higher (preferably 20 minutes or more), during the temperature elevation, while the highest temperature is kept, and during cooling. Though variable depending on the shape of the soft magnetic alloy ribbon, the intensity of the magnetic field is preferably 8 kAm⁻¹ or more in any case where it is applied in a width direction of the ribbon (a height direction in a wound magnetic core) or in a longitudinal direction of the ribbon (a circumferential direction in a wound magnetic core). The magnetic field may be a DC magnetic field, an AC magnetic field, or a pulse magnetic field. The heat treatment in a magnetic field provides the soft magnetic alloy ribbon with a DC hysteresis loop having high or low squareness. A heat treatment with no magnetic field provides the soft magnetic alloy ribbon with a DC hysteresis loop having intermediate squareness.

(6) Surface Treatment

The nano-crystalline, soft magnetic alloy may be provided with a coating of oxides such as SiO₂, MgO, Al₂O₃, etc. if necessary. A surface treatment during a heat treatment step provides high oxide bonding. Magnetic cores of soft magnetic alloy ribbons may be impregnated with resins, if necessary.

[5] Magnetic Device

Because magnetic devices (wound magnetic cores, etc.) using the nano-crystalline, soft magnetic alloy of the present invention have high saturation magnetic flux density, they are suitable for high-power applications in which high magnetic saturation is important, for example, large-current reactors such as anode reactors; choke coils for active filters; smoothing choke coils; magnetic pulse power devices used in laser power supplies, accelerators, etc.; magnetic cores for transformers, communications pulse transformers, motors and power generators; yokes; current sensors; magnetic sensors; antenna cores; electromagnetic-wave-absorbing sheets, etc.

The present invention will be explained in more detail referring to Examples below without intention of restriction. In each of Examples and Comparative Examples, the stripping temperature of a primary ultrafine-crystalline alloy ribbon, the ratio of a second exothermic peak, and the average particle size and volume fraction of fine crystal grains were measured by the following methods.

(1) Measurement of Stripping Temperature

The temperature of a primary ultrafine-crystalline alloy ribbon when stripped from a cooling roll by a nitrogen gas blown from a nozzle was measured by a radiation thermometer (FSV-7000E available from Apiste), and regarded as a stripping temperature.

(2) Measurement of Ratio of Second Exothermic Peak

In a DSC curve shown in FIG. 5(a), which was obtained using a differential scanning calorimeter (DSC-8230 available from Rigaku Corp.), the temperatures T_{X1}, T_{X3}, T_{X2S} and T_{X2E} were determined. Each temperature was a temperature at a crossing point of tangent lines extending from the inflection points of curves on both sides. A ratio of the heat quantity of a second exothermic peak [expressed by an area S₂ in FIG. 5(b)] to the total heat quantity of first and second exothermic peaks P1 and P2 generated by nano-crystallization [expressed by an area S in FIG. 5(a)] was calculated by the formula of S₂/S.

(3) Measurement of Average Particle Size and Volume Fraction of Fine Crystal Grains

The average particle size of fine crystal grains was determined by measuring the long diameters D_{L} and short diameters D_{S} of fine crystal grains in the number of n (30 or more) arbitrarily selected from a TEM photograph of each sample, and averaging them by the formula of Σ(D_{L}+D_{S})/2n. This was the same for primary ultrafine crystal grains. An arbitrary straight line having a length Lt was drawn on a TEM photograph of each sample, to determine the total length Lc of portions of the straight line which crossed fine crystal grains, thereby calculating a ratio of crystal grains along the straight line (L_{L}=Lc/Lt). Repeating this operation 5 times to average the L_{L}, the volume fraction of fine crystal grains was determined. The volume fraction V_{L}=Vc/Vt, wherein Vc is a total volume of fine crystal grains, and Vt is a volume of a sample, was approximated to V_{L}≈Lc³/Lt³=L_{L}³.

(4) Evaluation of Handling

With both longitudinal ends fixed, a ribbon-shaped test piece of 25 mm in width and 125 mm in length was twisted under tension to observe breakage, thereby evaluating its handling by the following standards. Acceptable in actual handling is that breakage does not occur by 180° twisting.
Excellent: Breakage did not occur by 180° twisting.
Good: Breakage did not occur by 90° twisting, but occurred by 180° twisting.

### Example 1

An alloy melt having a composition (atomic %) of Fe_{bal.}Cu_{1.4}Si₄B₁₄ was quenched in the air by a single-roll method using a copper-alloy-made, cooling roll shown in FIG. 6 under the following conditions, and stripped from the cooling roll at a temperature of 250° C., thereby obtaining a primary ultrafine-crystalline alloy ribbon of 25 mm in width, 20 μm in thickness and 1 km in length having an amorphous matrix, in which primary ultrafine crystal grains having an average particle size of 3 nm were dispersed at a volume fraction of 25%.

Peripheral speed of cooling roll: 28 m/s,

Inlet temperature of cooling water to cooling roll: 50° C., and

Outlet temperature of cooling water from cooling roll: 60° C.

FIG. 8 shows a DSC curve of this primary ultrafine-crystalline alloy ribbon. A first broad exothermic peak P1 due to nano-crystallization appeared in a wide temperature range from a crystallization initiation temperature T_{X1} of about 350° C. to a compound precipitation temperature T_{X3} of about 500° C., and a sharp third exothermic peak P3 due to the precipitation of an Fe—B compound appeared at 500° C. or higher. In the course of the first exothermic peak, there was a second small exothermic peak P2, which had a start temperature T_{X2s} of 420° C. and an end temperature T_{X2E} of 440° C. A ratio [PC3/(PC1+PC3)] of the heat quantity (PC3) of the second exothermic peak to the total heat quantity (PC1+PC3) of the first and second exothermic peaks P1 and P2 was 1.0%.

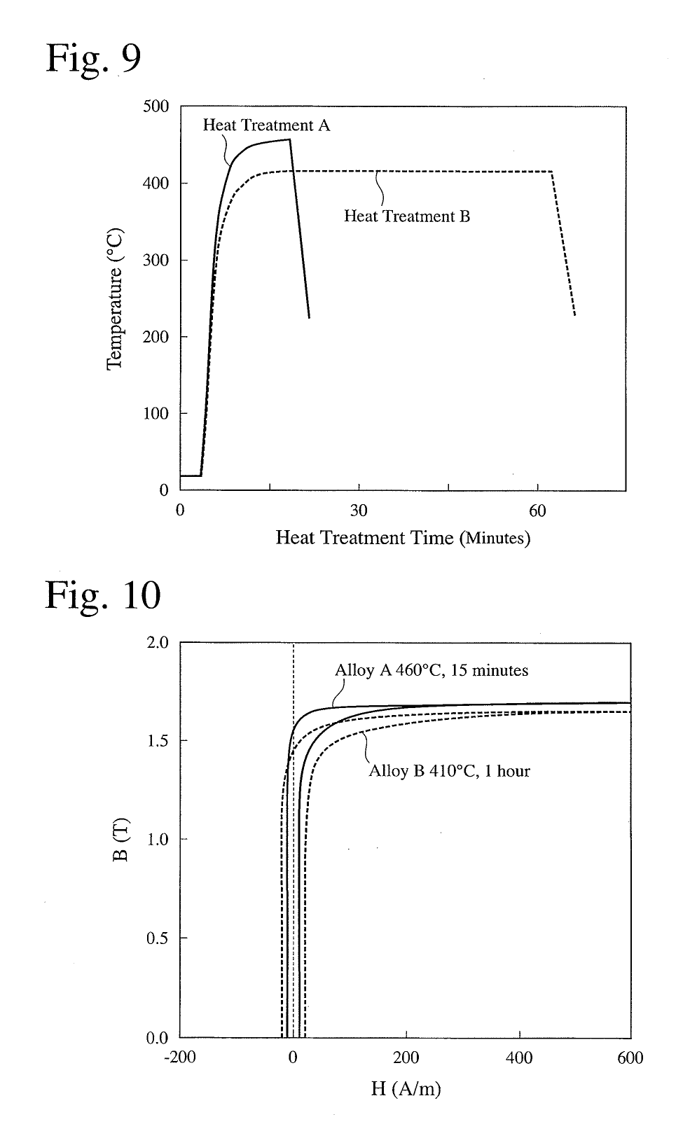

A single-plate sample of 25 mm×120 mm cut out of this primary ultrafine-crystalline alloy ribbon was charged into a heat treatment furnace, rapidly heated to 460° C. over about 15 minutes at an average temperature elevation speed of about 30° C./minute, taken out of the furnace as soon as its temperature reached 460° C., and then cooled to obtain a nano-crystalline, soft magnetic alloy ribbon. This heat treatment A is shown in FIG. 9. The time at which the sample was charged into the furnace was regarded as a heat treatment start time. The measurement of the average particle size and volume fraction of fine crystal grains in this nano-crystalline, soft magnetic alloy ribbon revealed that fine crystal grains having an average particle size of 20 nm were dispersed at a volume fraction of 45% in the amorphous phase of this nano-crystalline, soft magnetic alloy ribbon.

The observation of a transmission electron microscopic (TEM) photograph confirmed that the nano-crystalline, soft magnetic alloy was constituted by a nano-crystal layer having an average crystal grain size of 20 nm or less, a layer containing coarse crystal grains having an average particle size of 50 nm in an amorphous phase, and a matrix layer containing nano-crystal grains having an average particle size of 20 nm in this order from the surface. The coarse crystal grain layer was as deep as 1 μm or less from the surface, substantially not expanded. As a result, the second exothermic peak had a small percentage.

### Comparative Example 1

Using a copper-alloy-made, cooling roll shown in FIG. 6 at a peripheral speed of 28 m/s, the same alloy melt as in Example 1 was quenched with cooling water having an inlet temperature of 25° C. and an outlet temperature of 35° C. in the air, and stripped from the cooling roll at a temperature of 250° C., thereby obtaining a primary ultrafine-crystalline alloy ribbon of 25 mm in width and 20 μm in thickness having a structure comprising an amorphous matrix, in which primary ultrafine crystal grains having an average particle size of 1 nm were dispersed at a volume fraction of 4%. The temperatures of the cooling roll and cooling water were lower than those in Example 1. Though a second exothermic peak P2 was observed in a DSC curve of this primary ultrafine-crystalline alloy, a ratio of the heat quantity of the second exothermic peak to the total exothermic heat quantity by nano-crystallization was 3.1%.

This primary ultrafine-crystalline alloy ribbon was subject to the same heat treatment as in Example 1, to produce a nano-crystalline, soft magnetic alloy ribbon. This nano-crystalline, soft magnetic alloy ribbon had a structure having an amorphous phase, in which fine crystal grains having an average particle size of 26 nm were dispersed at a volume fraction of 40%. However, TEM observation revealed that a layer of coarse crystal grains having an average particle size of 50 nm was formed in an alloy layer to the depth of about 3.0 μm, resulting in large effective crystal magnetic anisotropy, and failing to obtain good soft magnetic properties.

### Example 2

To investigate the dependency of soft magnetic properties on heat treatment conditions, an alloy melt having a composition (atomic %) of Fe_{bal.}Cu_{1.4}Si₄B₁₄ was quenched in the air by a copper-alloy-made, cooling roll shown in FIG. 6, at a peripheral speed of 28 m/s, with cooling water having an inlet temperature of 50° C. and an outlet temperature of 60° C., and stripped from the cooling roll at a temperature of 250° C. to produce a primary ultrafine-crystalline alloy ribbon of 25 mm in width and 20 μm in thickness. In an amorphous matrix of this primary ultrafine-crystalline alloy, primary ultrafine crystal grains having an average particle size of 2 nm were dispersed at a volume fraction of 25%.

This primary ultrafine-crystalline alloy was subject to a high-temperature, short-period heat treatment A shown in FIG. 9, which comprised heating to 460° C. over 15 minutes, and then immediately cooling with air, to obtain a nano-crystalline, soft magnetic alloy A. Also, the same primary ultrafine-crystalline alloy was subject to low-temperature, long-period heat treatment B shown in FIG. 9, which comprised heating to 410° C. over 15 minutes, keeping this temperature for 45 minutes, and cooling with air, to obtain a nano-crystalline, soft magnetic alloy B. In both nano-crystalline, soft magnetic alloys A and B, fine crystal grains having an average particle size of 20 nm were dispersed at a volume fraction of 40% in an amorphous matrix. Their B-H curves are shown in FIG. 10. Both curves had hysteresis between a magnetization curve and a demagnetization curve in a magnetic flux density region of 1.5 T or more. This hysteresis seems to be due to a less saturable coarse crystal grain layer having high crystal magnetic anisotropy. This hysteresis differs depending on heat treatment conditions. Hysteresis remained up to about 800 A/m in the alloy B subject to the low-temperature, long-period heat treatment B, while hysteresis disappeared at about 300 A/m in the alloy A subject to the high-temperature, short-period heat treatment A, indicating extremely improved saturability in a low magnetic field.

### Example 3

Using a copper-alloy-made, cooling roll shown in FIG. 6 (a peripheral speed: 27-32 m/s, an inlet temperature of cooling water: 25-60° C., and an outlet temperature: 33-72° C.), alloy melts each having the composition (atomic %) shown in Table 1 were quenched in the air, and stripped from the cooling roll at a ribbon temperature of 250° C., to produce primary ultrafine-crystalline alloy ribbons of 25 mm in width and 16-25 μm in thickness. The alloy composition of each primary ultrafine-crystalline alloy ribbon, the inlet temperature and outlet temperature of cooling water, the average particle size and volume fraction of primary ultrafine crystal grains, and the ratio of the second exothermic peak are shown in Table 1. In these primary ultrafine-crystalline alloys, primary ultrafine crystal grains having an average particle size of 1-5 nm were dispersed at a volume fraction of 3-30% in an amorphous matrix. The ratio of the second exothermic peak to the total quantity of exothermic heat by nano-crystallization was determined in the same manner as in Example 1.

Each primary ultrafine-crystalline alloy ribbon was subject to a nano-crystallization heat treatment in a temperature range of 400-460° C. for 15-30 minutes, such that the maximum B₈₀ could be obtained, to produce a nano-crystalline, soft magnetic alloy ribbon. With respect to each nano-crystalline, soft magnetic alloy, the average particle size and volume fraction of fine crystal grains, the depth of a coarse crystal grain layer [a layer containing coarse crystal grains having an average particle size (about 50-100 nm) 2 times or more the average particle size of fine crystal grains in the matrix], coercivity, B₈₀ and B₈₀₀₀, and handling were measured. The measurement results are shown in Table 1. Each soft magnetic alloy ribbon had a structure in which fine crystal grains having an average particle size of 15-30 nm were dispersed at a volume fraction of 30-50%.

In mass production, having satisfactory soft magnetic properties and handling is extremely important; for example, even products twistable to 180° would be unsatisfactory if they had poor soft magnetic properties (B₈₀/B₈₀₀₀), and even if products had good soft magnetic properties, their handling would be difficult without twistability to 90°, resulting in low productivity. This Example provided soft magnetic alloy ribbons satisfactory in both soft magnetic properties and handling.

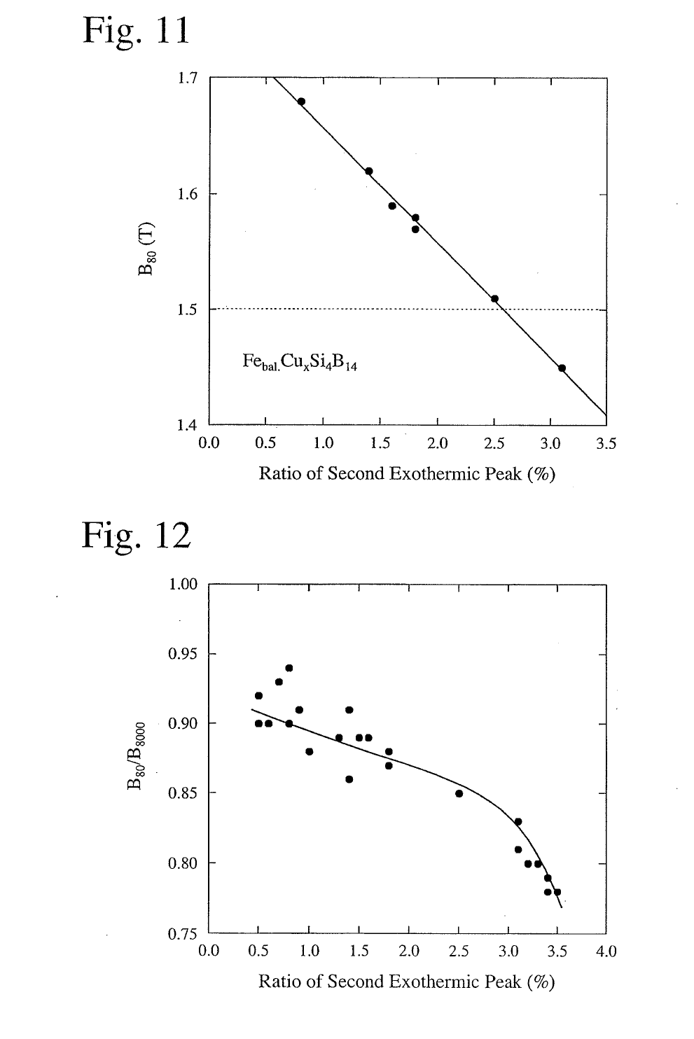

FIG. 11 shows the relation between B₈₀ and the ratio of the heat quantity of the second exothermic peak to the total quantity of exothermic heat by nano-crystallization in the alloy of Fe_{bal.}CuₓSi₄B₁₄ (x=1.4 and 1.5). In both cases where x=1.4 and 1.5, the data were aligned on the same line. FIG. 12 shows the relation between B₈₀/B₈₀₀₀ and the ratio of the heat quantity of the second exothermic peak to the total quantity of exothermic heat by nano-crystallization.

TABLE 1

| | Primary Ultrafine-Crystalline Alloy | | | | | |
|---|---|---|---|---|---|---|
| | | | | Primary Ultrafine | | |
| | | Cooling Water | | Crystal Grains | | Ratio of |
| | | Inlet | Outlet | Average | | Second |
| | Composition | Temperature | Temperature | Particle | % by | Exothermic |
| No. | (atomic %) | (° C.) | (° C.) | Size (nm) | Volume | Peak (%) |
| Example 3-1 | Fe_{bal.}Cu_{1.4}Si₄B₁₄ | 60 | 70 | 3 | 24 | 0.8 |
| Example 3-2 | Fe_{bal.}Cu_{1.4}Si₄B₁₄ | 50 | 60 | 3 | 21 | 1.4 |
| Example 3-3 | Fe_{bal.}Cu_{1.4}Si₄B₁₄ | 45 | 55 | 2 | 17 | 1.6 |
| Example 3-4 | Fe_{bal.}Cu_{1.4}Si₄B₁₄ | 40 | 51 | 2 | 15 | 1.8 |
| Example 3-5 | Fe_{bal.}Cu_{1.5}Si₄B₁₄ | 40 | 51 | 4 | 25 | 1.8 |
| Example 3-6 | Fe_{bal.}Cu_{1.5}Si₄B₁₄ | 35 | 44 | 2 | 11 | 2.5 |
| Comp. Ex. 3-1 | Fe_{bal.}Cu_{1.5}Si₄B₁₄ | 25 | 35 | 1 | 4 | 3.1 |
| Example 3-7 | Fe_{bal.}Cu_{1.3}Si₃B₁₃ | 60 | 69 | 3 | 25 | 0.7 |
| Example 3-8 | Fe_{bal.}Cu_{1.3}Si₃B₁₃ | 50 | 59 | 2 | 20 | 1.3 |
| Example 3-9 | Fe_{bal.}Cu_{1.5}Si₆B₁₄ | 60 | 70 | 3 | 22 | 0.9 |
| Example 3-10 | Fe_{bal.}Cu_{1.5}Si₆B₁₄ | 50 | 60 | 2 | 15 | 1.5 |
| Comp. Ex. 3-2 | Fe_{bal.}Cu_{1.5}Si₆B₁₄ | 25 | 33 | 1 | 4 | 3.3 |
| Example 3-11 | Fe_{bal.}Cu_{1.4}Si₁B₁₅ | 60 | 72 | 5 | 30 | 0.5 |
| Comp. Ex. 3-3 | Fe_{bal.}Cu_{1.4}Si₁B₁₅ | 25 | 35 | 2 | 12 | 3.2 |
| Example 3-12 | Fe_{bal.}Cu_{1.5}Si₈B₁₂ | 60 | 70 | 3 | 22 | 0.8 |
| Comp. Ex. 3-4 | Fe_{bal.}Cu_{1.5}Si₈B₁₂ | 25 | 35 | 1 | 4 | 3.4 |
| Example 3-13 | Fe_{bal.}Cu_{1.4}Si₂B₁₆ | 60 | 71 | 5 | 27 | 0.6 |
| Example 3-14 | Fe_{bal.}Cu_{1.4}Si₂B₁₆ | 50 | 60 | 4 | 24 | 1.4 |
| Comp. Ex. 3-5 | Fe_{bal.}Cu_{1.4}Si₂B₁₆ | 25 | 35 | 2 | 4 | 3.2 |
| Example 3-15 | Fe_{bal.}Cu_{1.3}Si₄B₁₀ | 60 | 70 | 4 | 25 | 0.5 |
| Comp. Ex. 3-6 | Fe_{bal.}Cu_{1.3}Si₄B₁₀ | 25 | 35 | 1 | 3 | 3.1 |
| Example 3-16 | Fe_{bal.}Cu_{1.7}Si₄B₂₀ | 50 | 60 | 3 | 18 | 1.0 |
| Comp. Ex. 3-7 | Fe_{bal.}Cu_{1.7}Si₄B₂₀ | 25 | 34 | 1 | 3 | 3.5 |
| Example 3-17 | Fe_{bal.}Cu_{1.4}Si₁B₂₀ | 60 | 69 | 4 | 23 | 0.8 |
| Comp. Ex. 3-8 | Fe_{bal.}Cu_{1.4}Si₁B₂₀ | 25 | 35 | 1 | 4 | 3.4 |
| Example 3-18 | Fe_{bal.}Cu_{1.3}B₁₅ | 50 | 60 | 4 | 24 | 0.5 |
| Example 3-19 | Fe_{bal.}Cu_{1.3}B₁₇ | 50 | 61 | 4 | 24 | 0.7 |
| Example 3-20 | Fe_{bal.}Cu_{1.4}B₁₉ | 50 | 60 | 5 | 26 | 0.8 |
| Example 3-21 | Fe_{bal.}Cu_{1.5}B₂₁ | 50 | 60 | 4 | 22 | 1.9 |

| | Nano-Crystalline, Soft Magnetic Alloy | | | | | |
|---|---|---|---|---|---|---|
| | Fine Crystal Grains | | Depth of | Magnetic | | |
| | Average | | Coarse | Flux Density | | |
| | Particle | % by | Crystal Grain | Ratio | Coercivity H_{c} | |
| No. | Size (nm) | Volume | Layer (μm) | B₈₀/B₈₀₀₀ | (A/m) | Handling |
| Example 3-1 | 20 | 45 | 0.8 | 0.94 | 6.8 | Good |
| Example 3-2 | 20 | 45 | 1.8 | 0.91 | 8.8 | Good |
| Example 3-3 | 18 | 45 | 2.1 | 0.89 | 14.0 | Excellent |
| Example 3-4 | 20 | 50 | 2.2 | 0.87 | 19.1 | Excellent |
| Example 3-5 | 18 | 45 | 2.1 | 0.88 | 6.9 | Excellent |
| Example 3-6 | 20 | 45 | 2.5 | 0.85 | 7.0 | Excellent |
| Comp. Ex. 3-1 | 26 | 40 | 3.0 | 0.81 | 7.2 | Excellent |
| Example 3-7 | 20 | 45 | 0.7 | 0.93 | 6.2 | Good |
| Example 3-8 | 20 | 45 | 1.6 | 0.89 | 8.5 | Good |
| Example 3-9 | 18 | 55 | 0.7 | 0.91 | 6.6 | Good |
| Example 3-10 | 20 | 50 | 1.9 | 0.89 | 9.2 | Excellent |
| Comp. Ex. 3-2 | 28 | 40 | 3.2 | 0.80 | 16.9 | Excellent |
| Example 3-11 | 22 | 40 | 0.5 | 0.92 | 7.0 | Good |
| Comp. Ex. 3-3 | 22 | 45 | 3.1 | 0.80 | 12.0 | Excellent |
| Example 3-12 | 16 | 50 | 0.9 | 0.90 | 7.5 | Good |
| Comp. Ex. 3-4 | 20 | 45 | 3.5 | 0.78 | 22.0 | Excellent |
| Example 3-13 | 20 | 45 | 0.8 | 0.90 | 6.9 | Good |
| Example 3-14 | 20 | 50 | 2.0 | 0.86 | 9.2 | Excellent |
| Comp. Ex. 3-5 | 22 | 45 | 3.0 | 0.80 | 11.1 | Excellent |
| Example 3-15 | 20 | 50 | 0.5 | 0.90 | 7.2 | Good |
| Comp. Ex. 3-6 | 24 | 40 | 3.0 | 0.83 | 15.0 | Excellent |
| Example 3-16 | 18 | 55 | 1.2 | 0.88 | 8.4 | Good |
| Comp. Ex. 3-7 | 30 | 40 | 3.5 | 0.78 | 21.3 | Excellent |
| Example 3-17 | 20 | 50 | 0.9 | 0.90 | 7.9 | Good |
| Comp. Ex. 3-8 | 24 | 40 | 3.8 | 0.79 | 20.0 | Excellent |
| Example 3-18 | 20 | 45 | 0.8 | 0.88 | 7.8 | Good |
| Example 3-19 | 20 | 45 | 0.8 | 0.89 | 7.7 | Good |
| Example 3-20 | 20 | 45 | 1.2 | 0.88 | 8.1 | Good |
| Example 3-21 | 20 | 45 | 1.4 | 0.87 | 8.8 | Good |

It is clear from Table 1, and FIGS. 11 and 12 that as the ratio of the heat quantity of the second exothermic peak to the total quantity of exothermic heat by nano-crystallization decreases, the coarse crystal grain layer becomes thin (resulting in fewer coarse crystal grains), and that as the ratio of the second exothermic peak increases, B₈₀/B₈₀₀₀ decreases, resulting in poor magnetic saturation characteristics. As shown in Table 1, the ratio of the second exothermic peak is correlated with the depth of the coarse crystal grain layer; a deeper coarse crystal grain layer contains a higher ratio of magnetically less saturable components, resulting in a low magnetic flux density in a low magnetic field of 80 A/m. When the ratio of the second exothermic peak is 3% or less, the coarse crystal grain layer has thickness of less than 3 μm, resulting in a B₈₀/B₈₀₀₀ ratio of substantially 85% or more. Because the coercivity H_{c} reflects on the nature of a matrix having good soft magnetic properties, it varies depending on the average crystal grain size of the matrix. As an overall tendency, a roll having higher cooling power provides a deeper coarse crystal grain layer, resulting in a larger average crystal grain size of the matrix. It has been found that B₈₀ tends to decrease, while H_{c} tends to increase, and that a larger amount of Cu produces more primary ultrafine crystal grains in the matrix of the primary ultrafine-crystalline alloy, reducing H_{c}. Though any samples had the second exothermic peak, their handling was substantially free from difficulty. Even with a relatively large ratio of the second exothermic peak, good handling was obtained.

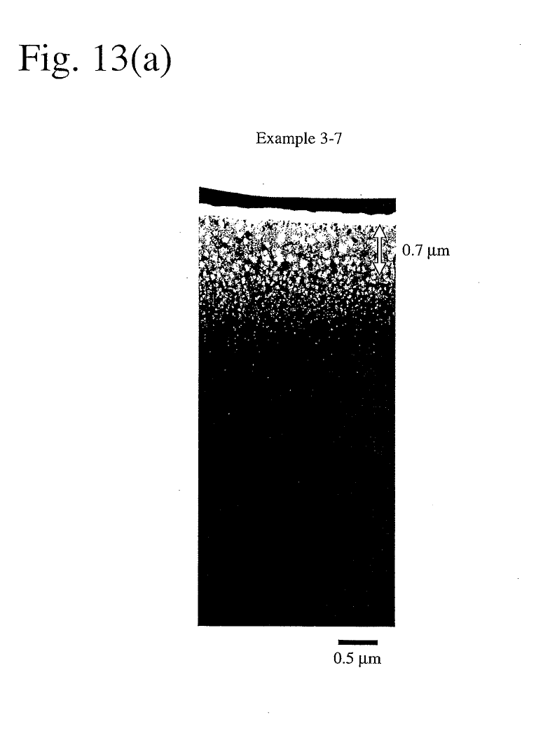

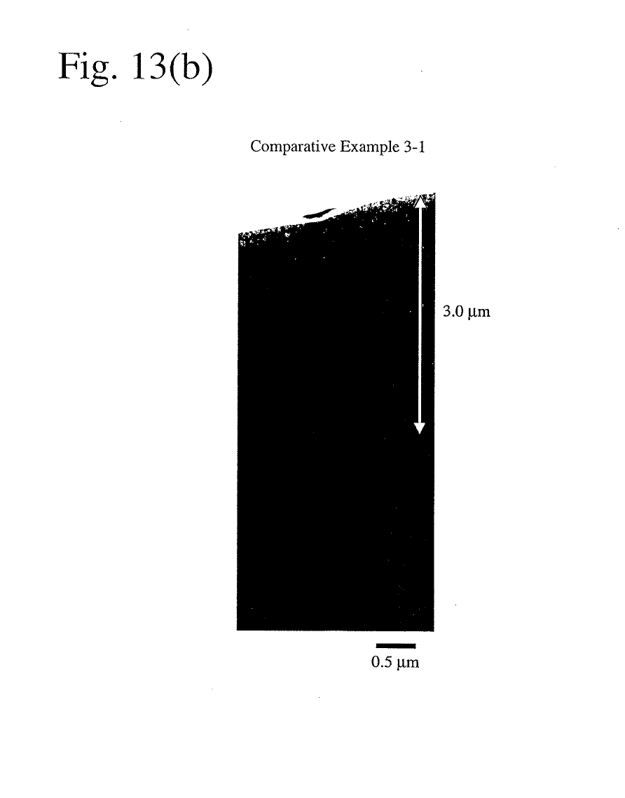

FIG. 13 shows the cross sections of the heat-treated samples of Example 3-7 and Comparative Example 3-1 near their roll-contacting surfaces. A layer containing coarse crystal grains had an average particle size 2 times or more the average crystal grain size (about 15 nm) of the matrix, the depth of this layer from the alloy surface being shown by a two-way arrow. A white layer on the surface is a surface-protecting carbon film disposed for taking a TEM photograph. FIG. 13(a) shows Example 3-7, in which the depth of the coarse crystal grain layer was about 0.7 μm when the ratio of the second exothermic peak was 0.7%. In Comparative Example 3-1 shown in FIG. 13(b), the depth of the coarse crystal grain layer was 3.0 μm when the ratio of the second exothermic peak was 3.1%.

### Example 4

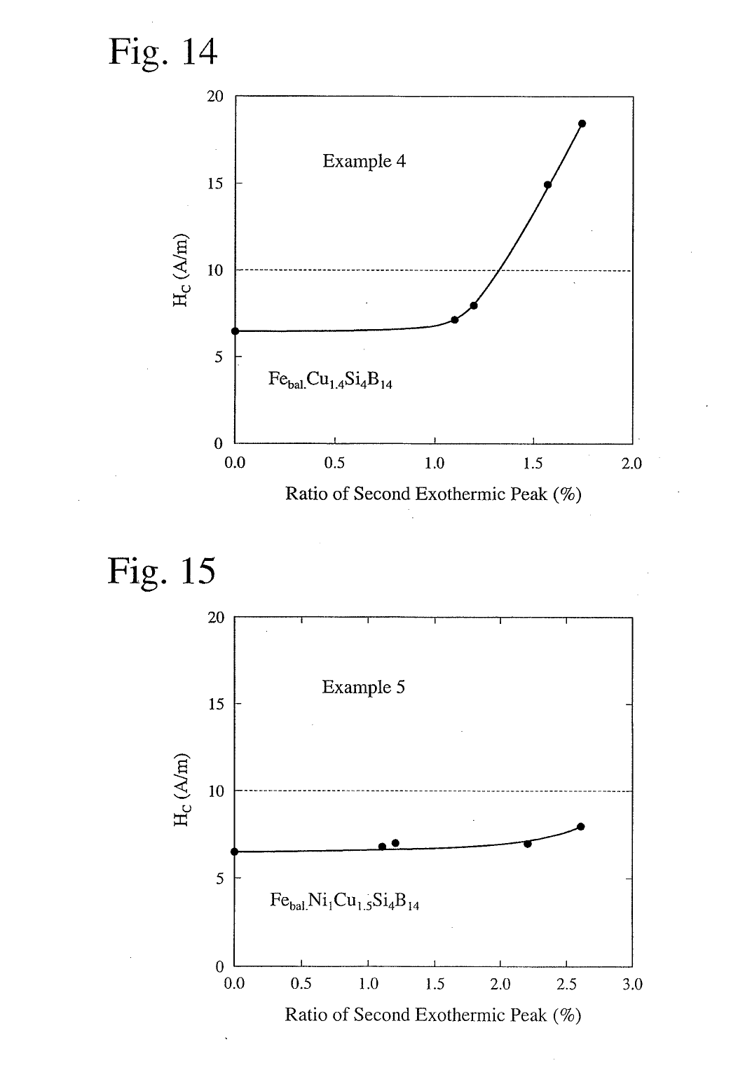

To change the heat quantity of the second exothermic peak, the inlet temperature of cooling water was changed from 25° C. to 60° C. to control the outlet temperature to 35-70° C., and an alloy melt having a composition (atomic %) of Fe_{bal.}Cu_{1.4}Si₄B₁₄ was quenched by a cooling roll at a peripheral speed of 28 m/s as in Example 1 in the air, and stripped from the cooling roll at a ribbon temperature of 250° C., to produce a primary ultrafine-crystalline alloy ribbon of 25 mm in width and 20 μm in thickness. In this primary ultrafine-crystalline alloy, primary ultrafine crystal grains having an average particle size of 1-5 nm were dispersed at a volume fraction of 5-25% in an amorphous matrix. This primary ultrafine-crystalline alloy was subject to a heat treatment comprising heating to 430° C. over about 15 minutes and keeping this temperature for 15 minutes, to obtain a nano-crystalline, soft magnetic alloy. FIG. 14 shows the relation between coercivity Hc and a ratio of the heat quantity of the second exothermic peak to the total quantity of exothermic heat by nano-crystallization in this nano-crystalline, soft magnetic alloy. As is clear from FIG. 14, the coercivity Hc was 15 A/m when the ratio of the second exothermic peak was 1.5%, but decreased to 10 A/m when the ratio was about 1.3%. When the ratio of the second exothermic peak was 1.1% or less, the coercivity Hc was 6-8 A/m.

### Example 5

With the inlet temperature of roll-cooling water adjusted to 35-70° C. to control the outlet temperature to 44-82° C., an alloy melt having a composition of Fe_{bal.}Ni₁Cu_{1.5}Si₄B₁₄ was quenched by a cooling roll at a peripheral speed of 28 m/s as in Example 1 in the air, and stripped from the cooling roll at a ribbon temperature of 250° C., to produce a primary ultrafine-crystalline alloy ribbon of 25 mm in width and 20 μm in thickness. The alloy composition of each primary ultrafine-crystalline alloy ribbon, the inlet temperature and outlet temperature of cooling water, the average particle size and volume fraction of primary ultrafine crystal grains, and a ratio of the second exothermic peak are shown in Table 2. In the primary ultrafine-crystalline alloy, primary ultrafine crystal grains having an average particle size of 2-5 nm were dispersed at a volume fraction of 18-26% in an amorphous matrix.

Each primary ultrafine-crystalline alloy was subject to a heat treatment comprising heating to 430° C. over about 15 minutes, and keeping this temperature for 15 minutes, to obtain a nano-crystalline, soft magnetic alloy. With respect to each nano-crystalline, soft magnetic alloy, the average particle size and volume fraction of fine crystal grains, the depth of a coarse crystal grain layer, coercivity, B₈₀ and B₈₀₀₀, and handling were measured. The measurement results are shown in Table 2.

FIG. 15 shows the relation between coercivity Hc and a ratio of the second exothermic peak. Even when the ratio of the second exothermic peak was 2.6%, as high B₈₀ as 1.57 T was obtained, and even when the ratio of the second exothermic peak was 1.5% or more, the coercivity Hc was 10 A/m or less. This seems to be due to the fact that the addition of Ni suppresses the growth of crystal grains in a region having a low number density of primary fine crystals.

As compared with the alloy of Example 3 shown in Table 1, which did not contain Ni, even a high ratio of the second exothermic peak did not provide a deep coarse crystal grain layer, suppressing increase in the coercivity H_{c}. It is clear that the addition of Ni suppresses the expansion of the coarse crystal grain layer, making it easy to have satisfactory handling characteristics and soft magnetic properties. It has thus been found that the addition of a proper amount of Ni reduces the dependency of soft magnetic properties on production conditions, thereby improving production efficiency.

TABLE 2

| | Primary Ultrafine-Crystalline Alloy | | | | | |
|---|---|---|---|---|---|---|
| | | | | Primary Ultrafine | | |
| | | Cooling Water | | Crystal Grains | | Ratio of |
| | | Inlet | Outlet | Average | | Second |
| | Composition | Temperature | Temperature | Particle | % by | Exothermic |
| No. | (atomic %) | (° C.) | (° C.) | Size (nm) | Volume | Peak (%) |
| Example 5-1 | Fe_{bal.}Ni₁Cu_{1.5}Si₄B₁₄ | 55 | 65 | 2 | 18 | 1.2 |
| Example 5-2 | Fe_{bal.}Ni₁Cu_{1.5}Si₄B₁₄ | 45 | 56 | 2 | 21 | 2.2 |
| Example 5-3 | Fe_{bal.}Ni₁Cu_{1.5}Si₄B₁₄ | 35 | 44 | 2 | 23 | 2.6 |
| Example 5-4 | Fe_{bal.}Ni₁Cu_{1.5}Si₄B₁₄ | 60 | 70 | 4 | 22 | 0.9 |
| Example 5-5 | Fe_{bal.}Ni₁Cu_{1.5}Si₄B₁₄ | 55 | 63 | 3 | 22 | 1.8 |
| Example 5-6 | Fe_{bal.}Ni₁Cu_{1.5}Si₄B₁₄ | 70 | 82 | 5 | 26 | 0.0 |

| | Nano-Crystalline, Soft Magnetic Alloy | | | | | |
|---|---|---|---|---|---|---|
| | Fine Crystal Grains | | | Magnetic | | |
| | Average | | Depth of Coarse | Flux Density | Coercivity | |
| | Particle | % by | Crystal Grain | Ratio | H_{c} | |
| No. | Size (nm) | Volume | Layer (μm) | B₈₀/B₈₀₀₀ | (A/m) | Handling |
| Example 5-1 | 20 | 45 | 0.8 | 0.93 | 7.0 | Excellent |
| Example 5-2 | 20 | 45 | 1.4 | 0.91 | 7.0 | Excellent |
| Example 5-3 | 20 | 45 | 1.8 | 0.89 | 8.0 | Excellent |
| Example 5-4 | 18 | 50 | 0.7 | 0.92 | 7.1 | Good |
| Example 5-5 | 18 | 45 | 1.5 | 0.90 | 8.2 | Excellent |
| Example 5-6 | 18 | 50 | 0.7 | 0.95 | 6.6 | Good |

### Example 6

Each of alloy melts having the compositions shown in Table 3, in which part of Fe was substituted by various elements, was quenched by a cooling roll at a peripheral speed of 28 m/s as in Example 1, with cooling water having an inlet temperature of 50° C. and an outlet temperature of 59-63° C. in the air, and stripped from the cooling roll at a ribbon temperature of 250° C., to produce a primary ultrafine-crystalline alloy ribbon of 25 mm in width and 20 μm in thickness. In the primary ultrafine-crystalline alloy, primary ultrafine crystal grains having an average particle size of 1-10 nm were dispersed at a volume fraction of 5-30% in an amorphous matrix. With the temperature of roll-cooling water changed, a ratio of the second exothermic peak of each primary ultrafine-crystalline alloy was measured. The alloy composition, the inlet temperature and outlet temperature of cooling water, the average particle size and volume fraction of primary ultrafine crystal grains, and the ratio of the second exothermic peak are shown in Table 3.

Each primary ultrafine-crystalline alloy was subject to a heat treatment comprising heating to 430° C. over about 15 minutes, and keeping this temperature for 15 minutes, to obtain a nano-crystalline, soft magnetic alloy. With respect to each nano-crystalline, soft magnetic alloy, the average particle size and volume fraction of fine crystal grains, the depth of a coarse crystal grain layer, coercivity, B₈₀ and B₈₀₀₀, and handling were measured. The measurement results are shown in Table 3.

TABLE 3

| | Primary Ultrafine-Crystalline Alloy | | | | | |
|---|---|---|---|---|---|---|
| | | | | Primary Ultrafine | | |
| | | Cooling Water | | Crystal Grains | | Ratio of |
| | | Inlet | Outlet | Average | | Second |
| | Composition | Temperature | Temperature | Particle | % by | Exothermic |
| No. | (atomic %) | (° C.) | (° C.) | Size (nm) | Volume | Peak (%) |
| Example 6-1 | Fe_{bal.}Cu_{1.2}Au_{0.1}B₁₆ | 50 | 61 | 2 | 11 | 1.1 |
| Example 6-2 | Fe_{bal.}Cu_{1.3}Au_{0.05}Si₉B₁₁ | 50 | 62 | 1 | 11 | 1.3 |
| Example 6-3 | Febal.Nb₁Cu_{1.4}Si₄B₁₄ | 50 | 60 | 2 | 16 | 1.2 |
| Example 6-4 | Febal.Mn₁Cu_{1.4}Si₄B₁₄ | 50 | 60 | 2 | 17 | 1.2 |
| Example 6-5 | Febal.Co₁Cu_{1.4}Si₄B₁₄ | 50 | 62 | 2 | 20 | 1.0 |
| Example 6-6 | Febal.V₁Cu_{1.4}Si₄B₁₄ | 50 | 62 | 2 | 20 | 1.1 |
| Example 6-7 | Febal.Cr₁Cu_{1.4}Si₄B₁₂ | 50 | 61 | 2 | 18 | 1.1 |
| Example 6-8 | Febal.Ti_{0.1}Cu_{1.4}Si₄B₁₄ | 50 | 59 | 2 | 8 | 0.8 |
| Example 6-9 | Febal.Zr₁Cu_{1.4}Si₄B₁₄ | 50 | 60 | 1 | 7 | 0.8 |
| Example 6-10 | Febal.Mo₁Cu_{1.4}Si₄B₁₄ | 50 | 60 | 1 | 7 | 1.0 |
| Example 6-11 | Febal.Hf₁Cu_{1.4}Si₄B₁₄ | 50 | 60 | 1 | 6 | 0.9 |
| Example 6-12 | Febal.Ta₁Cu_{1.4}Si₄B₁₄ | 50 | 60 | 1 | 5 | 0.8 |
| Example 6-13 | Febal.W₁Cu_{1.4}Si₄B₁₄ | 50 | 59 | 1 | 5 | 0.9 |
| Example 6-14 | Fe_{bal.}Cu_{4.0}Si₁₀B₁₅ | 50 | 61 | 10 | 30 | 0.2 |
| Example 6-15 | Fe_{bal.}Cu_{3.5}Si₃B₂₂ | 50 | 61 | 10 | 28 | 1.5 |
| Example 6-16 | Fe_{bal.}Cu_{1.4}Si₄B₁₄P₁ | 50 | 60 | 2 | 16 | 1.4 |
| Example 6-17 | Fe_{bal.}Cu_{1.4}Si₄B₁₄P₂ | 50 | 60 | 2 | 18 | 2.0 |
| Example 6-18 | Fe_{bal.}Cu_{1.5}Si₂B₁₀P₄ | 50 | 63 | 2 | 15 | 2.5 |
| Example 6-19 | Fe_{bal.}Cu_{1.5}Si₄B₁₄S_{0.1} | 50 | 61 | 2 | 20 | 1.3 |
| Example 6-20 | Fe_{bal.}Cu_{1.5}Si₄B₁₄C₁ | 50 | 60 | 2 | 20 | 1.0 |
| Example 6-21 | Fe_{bal.}Cu_{1.4}Si₄B₁₄Al_{0.1} | 50 | 61 | 2 | 14 | 0.9 |
| Example 6-22 | Fe_{bal.}Cu_{1.2}Si₄B₁₄Ga_{0.1} | 50 | 61 | 2 | 20 | 0.7 |
| Example 6-23 | Fe_{bal.}Cu_{1.5}Si₄B₁₄Ge_{0.1} | 50 | 59 | 2 | 21 | 0.7 |

| | Nano-Crystalline, Soft Magnetic Alloy | | | | | |
|---|---|---|---|---|---|---|
| | Fine Crystal Grains | | Depth of | | | |
| | Average | | Coarse | Magnetic Flux | | |
| | Particle | % by | Crystal Grain | Density Raito | Coercivity H_{c} | |
| No. | Size (nm) | Volume | Layer (μm) | B₈₀/B₈₀₀₀ | (A/m) | Handling |
| Example 6-1 | 16 | 55 | 1.8 | 0.90 | 7.2 | Good |
| Example 6-2 | 18 | 50 | 1.9 | 0.91 | 7.0 | Good |
| Example 6-3 | 16 | 40 | 1.8 | 0.89 | 8.1 | Good |
| Example 6-4 | 20 | 45 | 1.7 | 0.88 | 8.2 | Good |
| Example 6-5 | 18 | 45 | 1.5 | 0.90 | 8.4 | Good |
| Example 6-6 | 20 | 50 | 1.5 | 0.91 | 9.0 | Good |
| Example 6-7 | 20 | 45 | 1.5 | 0.89 | 8.3 | Good |
| Example 6-8 | 20 | 45 | 1.3 | 0.88 | 9.5 | Good |
| Example 6-9 | 16 | 40 | 1.2 | 0.90 | 8.2 | Good |
| Example 6-10 | 16 | 45 | 1.3 | 0.90 | 8.3 | Good |
| Example 6-11 | 14 | 45 | 1.4 | 0.89 | 8.4 | Good |
| Example 6-12 | 14 | 45 | 1.2 | 0.91 | 8.0 | Good |
| Example 6-13 | 18 | 45 | 1.4 | 0.91 | 7.5 | Good |
| Example 6-14 | 22 | 60 | 0.6 | 0.91 | 8.2 | Good |
| Example 6-15 | 24 | 60 | 1.5 | 0.92 | 8.6 | Good |
| Example 6-16 | 18 | 45 | 1.4 | 0.90 | 7.0 | Good |
| Example 6-17 | 16 | 50 | 2.3 | 0.90 | 7.1 | Good |
| Example 6-18 | 14 | 50 | 2.9 | 0.89 | 7.0 | Good |
| Example 6-19 | 20 | 45 | 2.0 | 0.88 | 9.2 | Good |
| Example 6-20 | 20 | 45 | 1.5 | 0.89 | 7.4 | Good |
| Example 6-21 | 22 | 45 | 1.4 | 0.89 | 9.3 | Good |
| Example 6-22 | 18 | 50 | 1.4 | 0.91 | 9.0 | Good |
| Example 6-23 | 20 | 50 | 1.5 | 0.91 | 9.1 | Good |

### Effect of the Invention

Because the particle sizes of primary ultrafine crystal grains can be made uniform regardless of the variation of production conditions, etc., the present invention can stably mass-produce nano-crystalline, soft magnetic alloys. Because the nano-crystalline, soft magnetic alloy of the present invention has a sufficient amorphous layer by suppressing the formation of a coarse crystal grain layer, it has excellent soft magnetic properties including high saturation magnetic flux density and squareness, and low coercivity and magnetic core loss without substantially deteriorating handleability. The method of the present invention can efficiently produce nano-crystalline, soft magnetic alloys having stable quality while suppressing the formation of coarse crystal grains.

The primary ultrafine-crystalline alloys and nano-crystalline, soft magnetic alloys of the present invention having such features can be used for various magnetic devices such as wound magnetic cores, etc., and particularly because of high saturation magnetic flux densities, they are suitable for high-power applications which should avoid magnetic saturation, for example, large-current reactors such as anode reactors; choke coils for active filters; smoothing choke coils; magnetic pulse power devices for laser power supplies and accelerators; magnetic cores for transformers, communications pulse transformers, motors and power generators; current sensors; magnetic sensors; antenna cores; electromagnetic-wave-absorbing sheets, etc.

1. A primary ultrafine-crystalline alloy having a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 5-30% by volume of primary ultrafine crystal grains having an average particle size of 30 nm or less are dispersed in an amorphous matrix; its differential scanning calorimetry (DSC) curve having a first exothermic peak and a second exothermic peak lower than said first exothermic peak between a crystallization initiation temperature T_{X1} and a compound precipitation temperature T_{X3}; and a ratio of the heat quantity of said second exothermic peak to the total heat quantity of said first and second exothermic peaks being 3% or less.

2. The primary ultrafine-crystalline alloy according to claim 1, wherein part of Fe is substituted by 0.1-2 atomic % of Ni.

3. A nano-crystalline, soft magnetic alloy having a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0≦x≦5, 10≦y≦22, 0≦z≦10, and x+y+z≦25, and a structure in which 30% or more by volume of fine crystal grains having an average particle size of 60 nm or less are dispersed in an amorphous matrix, the depth of a layer containing coarse crystal grains having an average particle size 2 times or more the average particle size of said fine crystal grains being 2.9 μm or less from the surface.

4. The nano-crystalline, soft magnetic alloy according to claim 3, which is obtained by heat-treating a primary ultrafine-crystalline alloy having a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 5-30% by volume of primary ultrafine crystal grains having an average particle size of 30 nm or less are dispersed in an amorphous matrix; its differential scanning calorimetry (DSC) curve having a first exothermic peak and a second exothermic peak lower than said first exothermic peak between a crystallization initiation temperature T_{X1} and a compound precipitation temperature T_{X3}; and a ratio of the heat quantity of said second exothermic peak to the total heat quantity of said first and second exothermic peaks being 3% or less.

5. A method for producing a nano-crystalline, soft magnetic alloy having a composition represented by the general formula: Fe_{100-x-y-z}AₓB_{y}X_{z}, wherein A is Cu and/or Au, X is at least one element selected from the group consisting of Si, S, C, P, Al, Ge, Ga and Be, and x, y and z are numbers (by atomic %) meeting the conditions of 0<x≦5, 10≦y≦22, 0≦z≦10, and x+y+z≦25, and a structure in which 30% or more by volume of fine crystal grains having an average particle size of 60 nm or less are dispersed in an amorphous matrix, the method comprising the steps of
ejecting an alloy melt having said composition onto a rotating cooling roll for quenching, thereby producing a primary ultrafine-crystalline alloy having a structure in which 5-30% by volume of primary ultrafine crystal grains having an average particle size of 30 nm or less are dispersed in an amorphous matrix, the surface temperature of said cooling roll being kept at such a temperature that a differential scanning calorimetry (DSC) curve of said primary ultrafine-crystalline alloy has a first exothermic peak and a second exothermic peak lower than said first exothermic peak between a crystallization initiation temperature T_{X1} and a compound precipitation temperature T_{X3}, and that a ratio of the heat quantity of said second exothermic peak to the total heat quantity of said first and second exothermic peaks is 3% or less, and then
subjecting said primary ultrafine-crystalline alloy to a heat treatment comprising temperature elevation to the highest temperature of (T_{X3}−50° C.) to (T_{X3}−30° C.), for 5-30 minutes including a temperature-elevating time and a highest-temperature-keeping time.

6. The method for producing a nano-crystalline, soft magnetic alloy according to claim 5, wherein said cooling roll is cooled with water, the inlet temperature of cooling water being 30-70° C., and the outlet temperature of cooling water after passing through the roll being controlled to 40-80° C.

7. A magnetic device formed by the nano-crystalline, soft magnetic alloy recited in claim 3.
